(19) United States
(12) Patent Application Publication
(10) Pub. No.: US 2006/0076186 A1
(43) Pub. Date: Apr. 13, 2006

(54) Life-saving device

(76) Inventor: Lars-Hakan Lindqvist, Saltsjobaden (SE)

Correspondence Address: YOUNG & THOMPSON, 745 SOUTH 23RD STREET, 2ND FLOOR, ARLINGTON, VA, 22202, US

(21) Appl. No.: 10/540,153

(22) PCT Filed: Dec. 18, 2003
(86) PCT No.: PCT/SE03/01989

§ 371 Date: Jun. 21, 2005

(30) Foreign Application Priority Data
Dec. 23, 2002 (SE) 0203846-1

(51) Int. Cl. A62B 1/06

(52) U.S. Cl. 182/70

(57) ABSTRACT

A life-saving device that comprises a storage unit (1), an opening (3) arranged at one end of the storage unit (1), a rope (10) attached to the storage unit (1), the rope (10) being received inside the storage unit (1) when the rope (10) is in inactive position, a weight (9) and a floating body (7), that a closed lifting loop (15) is connected to the rope (10) or that in the area of the end of the storage unit (101) that faces away from the opening (3) a fastening element (19) is connected to the rope (10), the fastening element (19) having a coupling function and may be detachably engaged with the rope (10). It is significant for the life-saving device according to the present invention that a portion of the rope (10; 210) is designed as a gripping ladder (10A; 210A).

### TECHNICAL FIELD OF THE INVENTION

The present invention relates to a life-saving device that comprises a storage unit, an opening arranged at one end of the storage unit, a rope attached to the storage unit, said rope being received inside the storage unit when the rope is in inactive position, a weight and a floating body, that a closed lifting loop is connected to the rope or that in the area of the end of the storage unit that faces away from the opening a fastening means is connected to the rope, said fastening means having a coupling function and may be detachably engaged with the rope. Generally, it should be mentioned that the life-saving device according to the present invention primarily has an intended use to rescue distressed persons that have landed in the water. However, the life-saving device may also be used in other connections, where alpine climbing and fire fighting may be mentioned in exemplifying and non-restricting purpose.

### PRIOR ART

From SE-C-354 454 a device of the type defined above is previously known. This device has been on the market for more than 30 years and has functioned in a satisfying way. When using the device the storage unit is opened and said unit is thrown away while the throwing person holds the free end of the throwing rope. In connection therewith the throwing rope will be discharged from the storage unit when the storage unit flies in the air up to the area of the distressed person. A function that is not present in connection with the device according to SE-C-354 454 is a lifting function, i.e. to transfer the distressed person from a lower level to a higher level.

From U.S. Pat. No. 4,713,033 a rescue bag equipped with a throwing rope is previously known. According to one embodiment said rescue bag has two strap parts that have one end attached to the bag and at their free end has one portion of a buckle. By bringing these portions of the buckle to engagement with each other a harness is formed around the distressed person and the distressed person may be pulled inwards. There is no indication whatsoever in U.S. Pat. No. 4,713,033 that the harness, formed by the strap parts, should be used to lift the distressed person from a lower level to a higher level. Besides, the distressed person must himself bring the portions of the bucket into engagement with each other and this means that the distressed person must turnaround in the water in order to have the bucket in the area of the chest when the portions are brought to engagement with each other.

### OBJECTS AND FEATURES OF THE INVENTION

A primary object of the present invention is to present a life-saving device of the type defined above, said device enabling transferring of the distressed person from a lower level to a higher level.

A further object of the present invention is to facilitate the lifting work regardless if this lifting work is carried out manually or by means of a winch or a pulley.

At least the primary object of the present invention is realised by means of a life-saving device that has been given the features of the appending independent claim 1. Preferred embodiments of the invention are defined in the dependent claims.

### BRIEF DESCRIPTION OF THE DRAWINGS

Below embodiments of the life-saving device according to the present invention will be described, reference being made to the accompanying drawings, where:

FIG. 1 shows a schematic view of an embodiment of a life-saving device according to the present invention, the storage unit being translucent in order to improve the clarity;

FIG. 2 shows a view of the life-saving device according to FIG. 1, the lifting loop being pulled out and the different parts of the rope illustrated;

FIGS. 3-5 illustrate different phases of life-saving of a distressed person that is in the water, the life-saving being carried out by means of the life-saving device according to FIGS. 1-2;

FIG. 6 shows a schematic view of an alternative embodiment of the life-saving device according to the present invention, the storage unit being translucent in order to improve the clarity;

FIG. 7 shows in top view a further alternative embodiment of the life-saving device according to the present invention;

FIG. 8 shows a storage unit being part of the life-saving device according to FIG. 7, said storage unit being translucent in order to improve the clarity;

FIG. 9 shows a view of the life-saving device according to FIG. 7, the storage unit being detached, the lifting loop being pulled out and the different parts of the rope being illustrated;

FIGS. 10-11 illustrate different phases of life-saving of a distressed person that is in the water, the life-saving being carried out by means of the life-saving device according to FIGS. 7 and 9.

### DETAILED DESCRIPTION OF PREFERRED EMBODIMENTS OF THE INVENTION

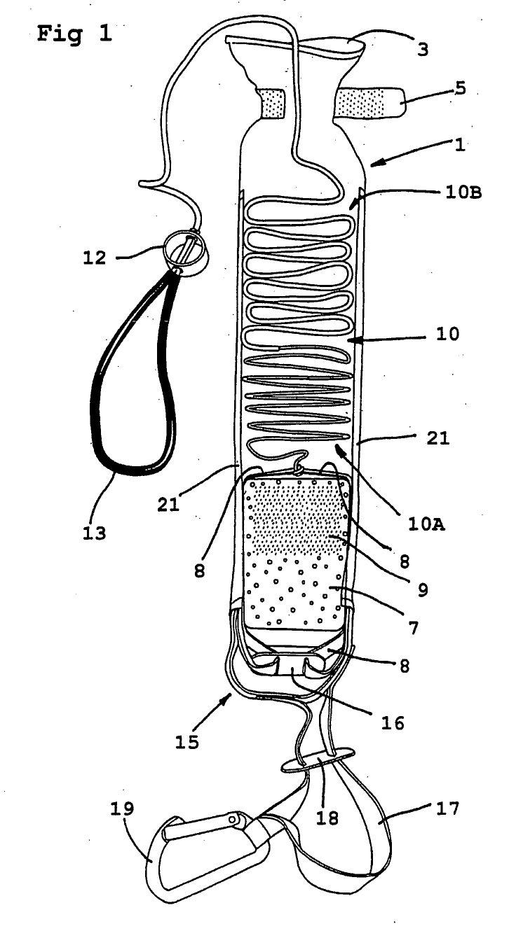

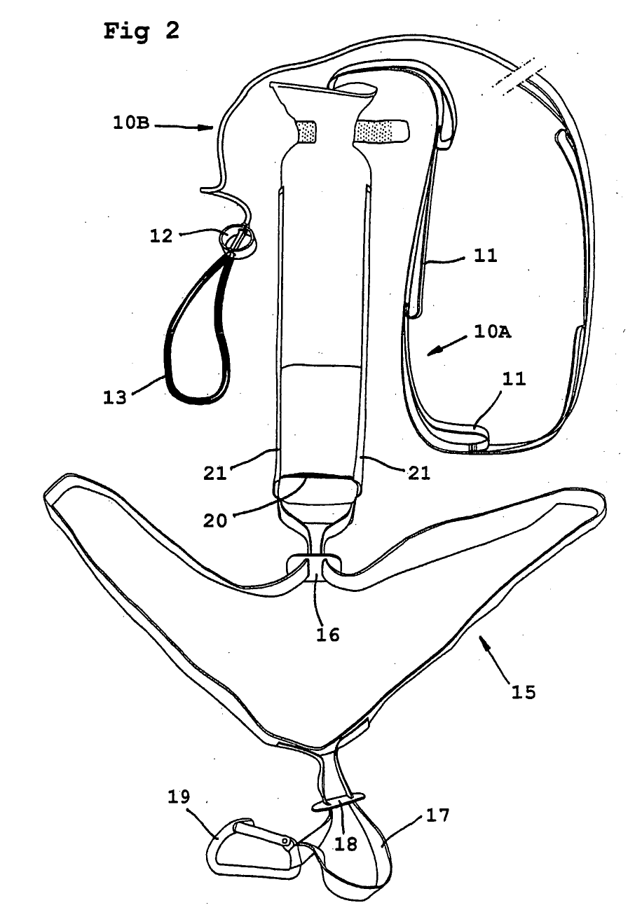

In FIGS. 1 and 2 the life-saving device according to the present invention is shown. The device comprises an elongated storage unit 1 that at one end has an opening 3 that may be closed by means of a Velcro tape 5. The storage unit 1 is manufactured from a flexible a material, preferably coated woven fabric. Inside the storage unit 1 a floating body 7 is received, said body 7 preferably constituting a cellular plastic or the like. In the shown embodiment a cavity is provided in the floating body 7 and a weight 9 is received in said cavity, said weight 9 may for instance constitute sand or lead bullets.

The life-saving device according to FIGS. 1 and 2 also comprises a rope 10 that in inactive position is received in the storage unit 1 that is shown in FIG. 1. The rope 10 itself constitutes of two portions and the portion located closest to the floating body 7 is a portion 10A that is equipped with loops 11, this portion 10A being shown more in detail in FIG. 2. This portion 10A is denominated “gripping ladder”, said gripping ladder 10A with one end being attached to a bridging strap 8 that extends from said end of the gripping ladder 10A, on both sides of the floating body 7, and to a lifting loop 15 that will be described more in detail below. In exemplifying and non-restricting purpose it should be mentioned that a suitable length of the gripping ladder 10A is about 3-8 m. The gripping ladder 10A is preferably manufactured from a floating material.

The second portion of the rope 10 constitutes a throwing rope 10B that preferably is manufactured from floating cordage and connected to the end of the gripping ladder 10A that faces away from the bridging strap 8. In exemplifying and non-restricting purpose it may be mentioned that the suitable length of the throwing rope 10B is about 30 m. At the end facing away from the gripping ladder 10A the throwing rope 10B carries an anti-slip member 12 for the foot to create an abutment on ice and slippery surfaces. The anti-slip member 12 is fixed on the throwing rope 10B by means of a knot or the like. Said end of the throwing rope 10B is connected to a first loop 13, whose function will be described more in detail below. The loop 13 is covered by a black plastic material that protects the rope of the loop 13 against sunlight/ultraviolet radiation.

As is evident from FIG. 2 the gripping ladder 10A is equipped with a number of loops 11 that have been created by manufacturing the gripping ladder 10 from two similar straps, one being longer than the other. The longer strap is attached to the shorter and hence loops 11 are created, the life-saver may easily grip or attach a hook to said loops 11. The structural design of the gripping ladder 10A may vary although it is normally sewn from straps that are arranged in such a way that a number of open loops are created that the life-saver easily may grip.

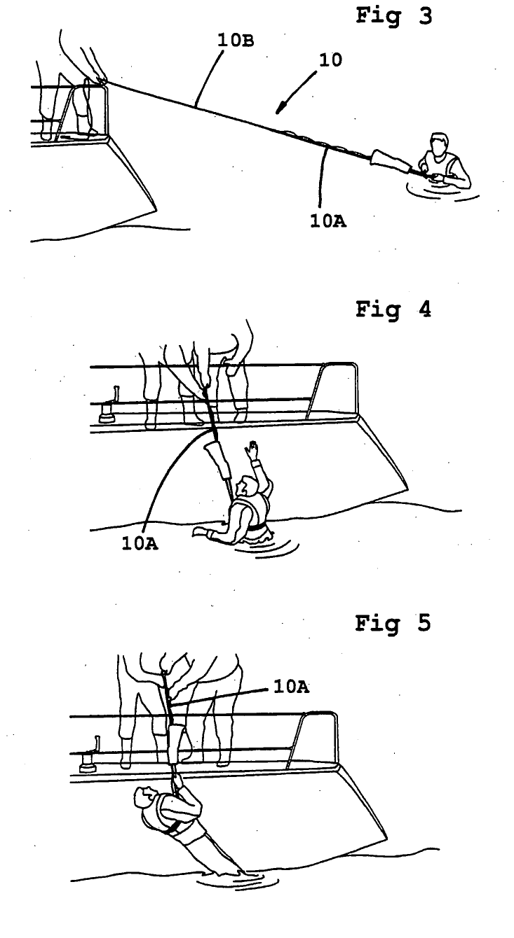

The life-saving device according to FIGS. 1 and 2 also comprises a lifting loop 15 that is shown most in detail in FIG. 2. It is evident that the ends of the lifting loop 15 are connected to the bridging strap 8, more precisely the bridging strap 8 is transformed into the lifting loop 15. Thus, there is a direct connection between the gripping ladder 10A and the lifting loop 15, more precisely the lifting loop 15 and the bridging strap 8 normally constitute one piece. The lifting slope 15 is closed and thus located in connection to the end of the storage unit 1 that faces away from the opening 3. The portion of the closed lifting loop 15 that is located furthest away from the storage unit 1 is reinforced by the provision of a batten on the inner side of the lifting loop 15. The batten reinforces the lifting loop 15 although the lifting loop 15 still is flexible. Since the batten is mounted on the inner side of the loop 15 it is not visible in FIG. 2. The lifting loop 15 passes through a first locking washer 16 that is displaceable relative to the lifting loop 15. Thereby, the length of the portion of the lifting loop 15 that surrounds the distressed person may be varied, this being enlightened below in connection with FIGS. 3-5.

In the area of the portion of the lifting loop 15 that is located furthest away from the storage unit 1 the lifting loop 15 is equipped with a second loop 17 that in the shown embodiment is sewn to the lifting loop 15. The second loop 17 runs through a second locking washer 18 by which the size of the active portion of the second loop 17 may be varied. A spring hook 19 is also attached to the second loop 17, said spring hook 19 being placed on one side of the second loop 17. Thereby, the spring hook 19 do not affect the accessibility to the second loop 17 to any degree worth mentioning. The spring hook 19 is not compulsory but can be eliminated within the scope of the invention. To store the spring hook 19 the storage unit 1 is equipped with a first pocket 20 that is provided in the area of the end of the storage unit 1 that faces away from the opening 3. The opening of the first pocket 20 faces away from the opening 3.

The material in the lifting loop 15 is preferably a material that floats in water. This facilitates for the distressed person to handle the lifting slope 15. The lifting slope 15 preferably constitutes a strap about 4 cm in width while the gripping ladder 10A may constitutes a more narrow strap. The length/the circumference of the closed lifting loop 15 is preferably about 2 m.

As is evident from both FIGS. 1 and 2 the storage unit 1 is equipped with elongated second pockets 21 on opposite side portions. As is evident from FIG. 1 these second pockets 21 are intended to receive the major portion of the lifting slope 15, where every second pocket 21 receives a double folded portion of the lifting slope 15. The batten on the lifting slope 15 thereby facilitates the entering of the lifting slope 15 in the second pockets 21 by the reinforcing function that the batten has on the lifting slope 15.

FIG. 1 shows the life-saving device in inactive, stored position apart from the first loop 13 that extends outside the opening 3 that is closed by the Velcro tape 5. In connection therewith the anti-slip member 12 constitutes a stop to prevent the rope to slide out of the storage unit 1. In the inactive position the spring hook 19 should be completely inserted into the pocket 20, see FIG. 2.

In FIGS. 3-5 the use of the life-saving device according to FIGS. 1-2 is schematically illustrated. Thereby, the distressed person is in the water and the life-savers are on a boat. When the life-savers are to rescue the distressed person by means of the life-saving device according to FIGS. 1-2 the opening 3 is initially exposed and a limited portion of the throwing rope 10B is pulled out through the opening 3, i.e. the life-saving device is in the position shown in FIG. 1. Then the person that is to throw the life-saving device enters the hand that not constitutes the throwing hand in the loop 13 and with the wrist in the loop 13 he/she may support oneself with the hand that not constitutes the throwing hand. With his/her throwing hand the person now grips the storage unit 1 in the area of its opening 3. The life-saver now throws the storage unit 1 in direction towards the distressed person and the weight 9 functions as throwing weight. It is extremely important that when the device is thrown the spring hook 19 is inserted into the first pocket 20. Thereby, the risk is eliminated that the spring hook 19 may damage the distressed person if the device lands in the absolute vicinity of the distressed person. The pocket 20 may also be upholstered to further reduce the risk for damages. When the distressed person gets hold of the life-saving device he/she grips the second loop 17 and then pulls the lifting loop 15 out of the second pockets 21. Now the position shown in FIG. 2 of the lifting loop 15 is in principle assumed. In order to facilitate for the distressed person to pull the lifting loop 15 out of the second pockets 21 the life-saver may tighten the rope 10 in order to achieve a suitable counter force. When the lifting loop 15 is pulled out of the second pockets 21 it will float in the water due to the material of the lifting loop 15, see above. However, this function may be somewhat reduced if the second loop 17, that is attached to the lifting loop 15, carries a spring hook 19.

When the distressed person has pulled out the lifting loop 15 to the position that in principle is shown in FIG. 2 the distressed person grabs the lifting loop 15 and passes it over the head for further positioning below the arms. Then the distressed person pulls the locking washer 16 towards himself and the portion of the lifting loop 15 that extends around the distress person is adapted to the size of the distressed person. This portion is denominated the effective length of the lifting loop 15. This position is schematically illustrated in FIG. 3.

Now the life-savers on the boat pull the distressed person towards the boat by means of the rope 10. Initially, the throwing rope 10B is used, see FIG. 3. When the pulling inwards of the distressed person has advanced so far that the distressed person is close to the boat, see FIG. 4, the life-savers have normally got hold of the gripping ladder 10A and hence they do not risk to slide with their hands along the rope 10.

In FIG. 5 it is illustrated how the line-savers lift the distressed person out of the water by gripping the loops 11 of the gripping ladder 10A, the distressed person thereby hanging in the lifting loop 15. As pointed out above there must exist a connection between the lifting loop 15 and the rope 10, more precisely the gripping ladder 10A of the rope 10.

In case the distressed person only is to be pulled out of for instance a hole in the ice it is sufficient if the distressed person enters his hand in the second loop 17 and then tightens this loop 17 around his hand with the second locking washer 18. In this connection it should be pointed out that the location of the spring hook 19 on the second loop 17 brings about that the tightening of the loop 17 not is prevented.

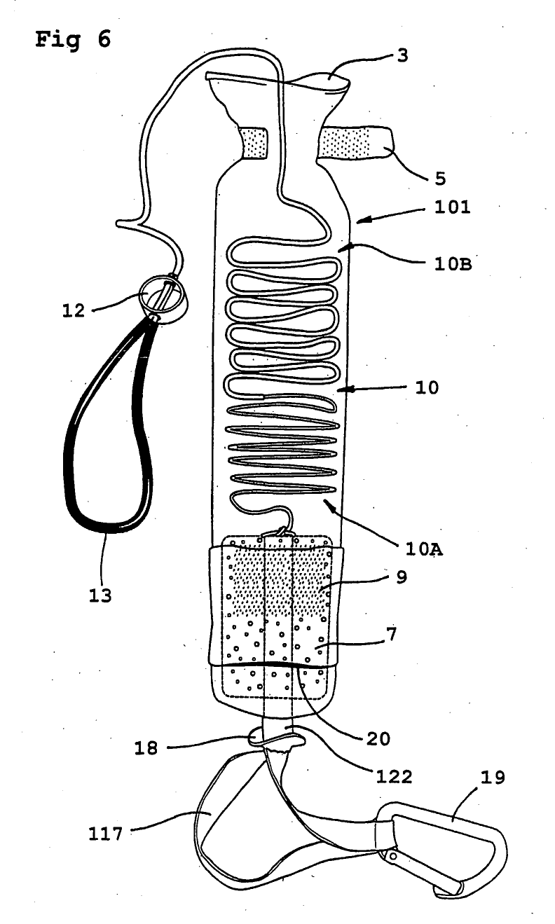

The alternative embodiment of the life-saving device according to the present invention, shown in FIG. 6, comprises likewise the life-saving device described above a storage unit 101, an opening 3, a Velcro tape 5, a floating body 7 with enclosed weight 9, a rope 10, an anti-slip member 12, a first loop 13, a second loop 117, a second locking washer 18, a spring hook 19 and a first pocket 20. In this connection the details that in principle are identical for both embodiments have been given the same reference numeral.

The spring hook 19 is connected to the rope 10 via the second loop 117 and a strap 122 that extends through the floating body 7.

In principle the life-saving device according to FIG. 6 differs from the life-saving device according to FIGS. 1 and 2 in that the embodiment according to FIG. 6 is void of a separate lifting loop. The embodiment according to FIG. 6 has a gripping ladder 10A that together with a throwing rope 10B constitute the rope 10. However, the embodiment according to FIG. 6 may also be used in such a way that a loop is provided around the distressed person, and by this loop the distressed person may be pulled out of a hole in the ice and in emergency cases also be lifted from a lower level to a higher level.

When using the life-saving device according to FIG. 6 the initial handling corresponds to what has been described above in connection with FIGS. 3-5. When the device according to FIG. 6 has been thrown to the distressed person the rope 10 is discharged from the storage unit 101 that floats in the water thanks to the floating body 7. The distressed person now grips the second loop 117 and brings the storage unit 117 around the body. Then the distressed person connects the spring hook 19 to the rope 10, in the area where the rope 10 emerges from the storage unit 101, i.e. where the rope 10 constitutes the gripping ladder 10A. Thereby, it is also made possible that the spring hook 19 may be connected to a loop of the gripping ladder 10A. By such a handling of the life-saving device according to FIG. 6 a loop is formed around the body of the distressed person. The distressed person may now be pulled out of a hole in the ice or even lifted in principally the corresponding way as illustrated in FIGS. 3-5.

It should also be pointed out that since the embodiment according to FIGS. 1 and 2 is equipped with a spring hook this embodiment can be used in principally the corresponding way as the embodiment according to FIG. 6 and in such a case the spring hook 19 is hitched to the gripping ladder 10A. If the distressed person carries a rucksack it might during certain circumstances be easier to create the loop around the body by means of the storage unit 1, the spring hook 19 and the gripping ladder 10A than for the distressed person to enter the lifting loop 15.

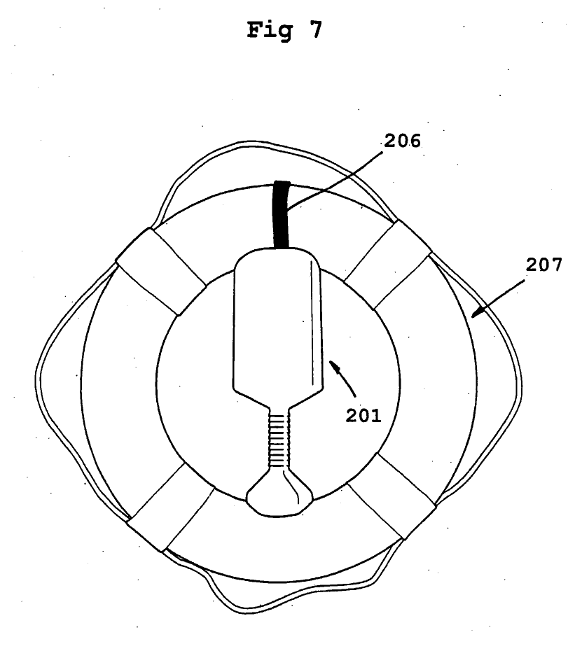

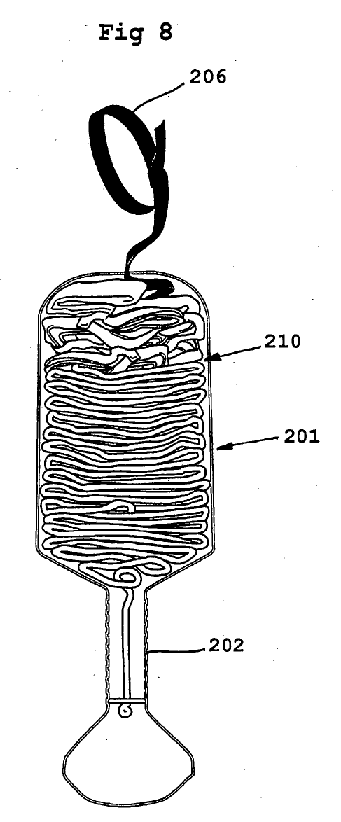

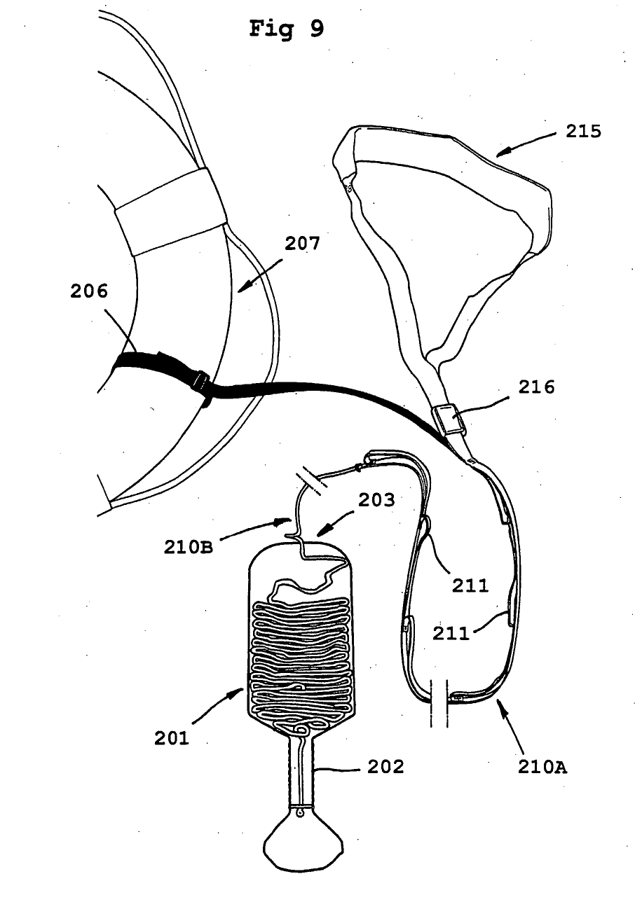

In FIGS. 7 and 8 a further alternative embodiment of a life-saving device according to the present invention is shown. This embodiment comprises a life buoy 207 that in a number of respects fulfils the same function as the floating body 7 in the embodiments described above. Thus, the life buoy 207 functions as both floating body and throwing weight. The embodiment according to FIGS. 7 and 8 also comprises an elongated storage unit 201 that in its inactive position is clamped in the opening of the life buoy 207. As is evident from FIG. 9 the storage unit 201 has an opening 203 at one end, said opening 203 being closed when the storage unit 201 is clamped in the opening of the life buoy 207. The storage unit 201 is equipped with a handle 202 that is used to grab the storage unit 201 when said storage unit 201 is dismounted from the opening in the life buoy 207.

The life-saving device according to FIGS. 7 and 8 also comprises a rope 210 that in accordance with the embodiments described above comprises a gripping ladder 210A and a throwing rope 210B. In its inactive position the rope 210 is received in the storage unit 201. However, a limited length 206 of the rope 210 is constantly located outside the storage unit 201 and is fastened around the life buoy 207. This sub length 206 is preferably protected against ultraviolet radiation, e.g. by a plastic coating.

The life-saving device according to FIGS. 7 and 8 also comprises a lifting loop 215 that principally is of the corresponding design as the lifting loop 15 of the embodiment according to FIGS. 1 and 2. This means that the lifting loop 215 is equipped with a belt fastener 216 that in a released position may be displaced relative to the lifting loop 215 to adjust the size of the lifting loop 215 to the distressed person. The lifting loop 215 is connected to the rope 210, more precisely to the portion of the rope 210 that is designed as the gripping ladder 210A.

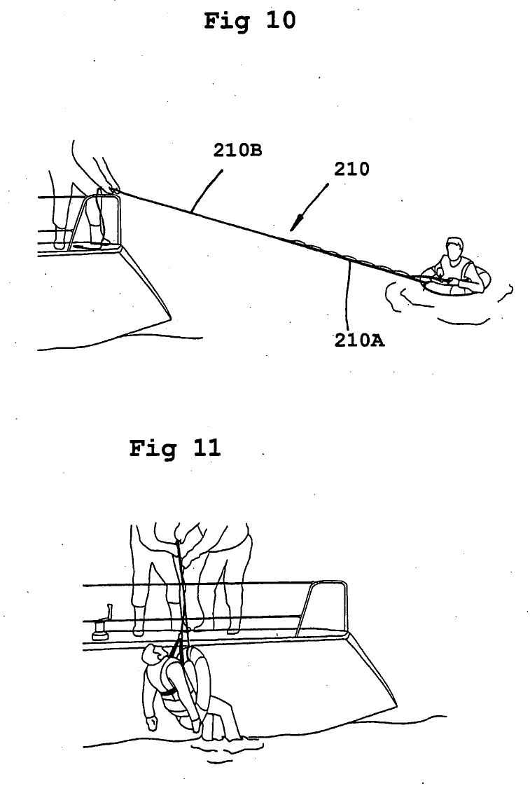

The use of the life-saving device according to FIGS. 7 and 9 is schematically illustrated in FIGS. 10 and 11, where the distressed person is in the water and the life-savers are on a boat. When using the life-saving device according to FIGS. 7 and 9 the storage unit 201 is dismounted from its location in the opening of the life buoy 207. The life-saver grips the handle 201 with a firm grip, preferably using the hand that not constitutes the throwing hand. Then the life-saver grips the life buoy 207 with this throwing hand and throws the life buoy 207 towards the distressed person, the life buoy 207 in this connection serving as throwing weight. While the life buoy 207 is in the air a portion of the rope 210, more precisely the throwing rope 210B and a portion of the gripping ladder 210A, will be discharged from the storage unit 201. When the life buoy 207 has landed in the water it will serve as a floating body, i.e. the life buoy 207 will float on the water surface.

The most natural way for the distressed person to act is to enter the life buoy 207 from below and to pass the lifting loop 215 over the head with the life buoy 207 as floating aid. In FIGS. 10 and 11 that situation is illustrated, i.e. the distressed person is inside the life buoy 207 and has the lifting loop 215 below his arms.

The life-savers on the boat now pulls, by means of the rope 201, the distressed person towards the boat. In the initial phase the throwing rope 210B is used, see FIG. 10. When the pulling inwards of the distressed person has advanced so far that the distressed person is adjacent the boat, see FIG. 11, the life-savers have normally got hold of the gripping ladder 210A and they do not run the risk to slide with their hands along the rope 210. Now the life-savers lift the distressed person out of the water by gripping the loops 211 of the gripping ladder 210A, the distressed person hanging in the lifting loop 215. Alternatively, a lifting hook may be attached to any of the loops 211 of the gripping ladder 210A.

It is common for all the embodiments described above of the life-saving device according to the present invention that the rope 10; 210 should have a sufficient length in order to enable the use of the life-saving device as “life-sling”. The length should be in the magnitude of 30 m. This means that if the storage unit 1; 101 or the life buoy 207 lands at a certain distance from the distressed person the life-savers may circle the boat around the distressed person. Thereby, the storage unit 1; 101 or the life buoy 207 will be within reach for the distressed person.

### FEASIBLE MODIFICATIONS OF THE INVENTION

In the embodiment according to FIGS. 1-2 the lifting loop 15 is provided at the end of the storage unit 1 that faces away from the opening 3. However, within the scope of the invention it is also feasible that the lifting loop is provided where the gripping ladder 10A joins the storage unit 1 according to the embodiment of FIGS. 1-2. In such a case the gripping ladder 10A is provided between the lifting loop 15 and the throwing rope 10B.

It is general for the life-saving device according to the present invention that it should comprise certain components of which a floating body, a throwing weight, a rope and a storage unit are extremely important components. In the embodiments described above different examples have been put forward, the exemplification however in no way being exhaustive. In this connection it should especially be mentioned a further embodiment where the floating body/the throwing weight constitutes a life buoy that preferably is in the shape of a horse shoe and that the storage unit of the rope generally is stationary, e.g. a “letter box” that is mounted on a sail boat.

1. Life-saving device that comprises a storage unit (1; 101; 201), an opening (3; 203) arranged at one end of the storage unit (1; 101; 201), a rope (10; 210) attached to the storage unit (1; 101; 201), said rope (10; 210) being received inside the storage unit (1; 101; 201) when the rope (10; 210) is in inactive position, a weight (9; 207) and a floating body (7; 207), that a closed lifting loop (15; 215) is connected to the rope (10; 210) or that in the area of the end of the storage unit (101) that faces away from the opening (3) a fastening means (19) is connected to the rope (10), said fastening means (19) having a coupling function and may be detachably engaged with the rope (10), characterized in that a portion of the rope (10; 210) is designed as a gripping ladder (10A ; 210A).

2. Device according to claim 1, characterized in that the gripping ladder(10A; 210A) comprises a number of loops (11; 211).

3. Device according to claim 1, characterized in that the storage unit (1) has elongated pockets (21) for receiving the lifting loop (15), hand that the lifting loop (15), along a portion of its length, is equipped with stiffening means.

4. Device according to claim 1, characterized in that the floating body/the weight body constitutes a life buoy (207), and that the storage unit (201) in inactive position is clamped in the opening of the life buoy (207).

5. Device according to claim 1, characterized in that the lifting loop (15; 215) has a means (16; 216) that is displaceable along the lifting loop (15; 215) in order to adjust the effective length of the lifting loop (15; 215).

6. Device according to claim 1, characterized in that a second loop (17) is connected to the lifting loop (15).

7. Device according to claim 6, characterized in that a fastening means (19) with coupling function is attached to the second loop (17), and that this fastening means (19) can be brought to a detachable engagement with the rope (10).

8. Device according to claim 6, characterized in that the storage unit (1; 101) has a pocket (20) for the fastening means (19).

9. Device according to claim 1, characterized in that the weight (9; 207) is integrated with the floating body (7; 207).

10. Device according to claim 2, characterized in that the first loop (13)/the rope portion (206) is covered with a material that protects against sunlight/ultraviolet radiation.

11. Device according to claim 2, characterized in that the storage unit (1) has elongated pockets (21) for receiving the lifting loop (15), hand that the lifting loop (15), along a portion of its length, is equipped with stiffening means.

12. Device according to claim 2, characterized in that the floating body/the weight body constitutes a life buoy (207), and that the storage unit (201) in inactive position is clamped in the opening of the life buoy (207).

13. Device according to claim 7, characterized in that the storage unit (1; 101) has a pocket (20) for the fastening means (19).

14. Device according to claim 3, characterized in that the first loop (13)/the rope portion (206) is covered with a material that protects against sunlight/ultraviolet radiation.

15. Device according to claim 5, characterized in that the first loop (13)/the rope portion (206) is covered with a material that protects against sunlight/ultraviolet radiation.

16. Device according to claim 6, characterized in that the first loop (13)/the rope portion (206) is covered with a material that protects against sunlight/ultraviolet radiation.

17. Device according to claim 7, characterized in that the first loop (13)/the rope portion (206) is covered with a material that protects against sunlight/ultraviolet radiation.

18. Device according to claim 8, characterized in that the first loop (13)/the rope portion (206) is covered with a material that protects against sunlight/ultraviolet radiation.

19. Device according to claim 9, characterized in that the first loop (13)/the rope portion (206) is covered with a material that protects against sunlight/ultraviolet radiation.
